(19) United States
(12) Patent Application Publication
(10) Pub. No.: US 2026/0353100 A1
(43) Pub. Date: Nov. 5, 2026

(54) METHOD AND SYSTEM FOR ENHANCED NETWORK RESOURCE ALLOCATION BASED ON CHRONOLOGICALLY AWARE SEQUENCE CALIBRATION

(71) Applicant: Verizon Patent and Licensing Inc., Basking Ridge, NJ (US)

(72) Inventors: Ravi Hs, Bangalore (IN); Rohan Agarwal, Bangalore (IN); Shivam Sahu, Zirakpur (IN)

(73) Assignee: Verizon Patent and Licensing Inc., Basking Ridge, NJ (US)

(21) Appl. No.: 19/197,133

(22) Filed: May 2, 2025

(51) Int. Cl. H04W 16/18; H04W 16/22

(52) U.S. Cl. CPC H04W 16/18; H04W 16/22

(57) ABSTRACT

The present teaching is for forecasting resource need of a network. Historical time series (TS) representing the network's past resource consumption includes past TS data and past chronically aware sequences (CASs) and is used to obtain a CAS TS forecast model for estimating an enhanced forecast of the network's resource needs. A CAS forecast model is obtained for each CAS. When real time data is received, the CAS forecast models are used to estimate predicted CAS forecasts. The CAS TS forecast model is used to generate an enhanced time series forecast based on the real time data, the actual CASs, and the predicted CAS forecasts.

### BACKGROUND

Time series forecasting may be applied for predicting various trends, needs, and actions. For example, an upcoming need for resource allocation to a cell tower may be forecasted based on observed past time series data on the consumption of the resource associated with the cell tower. As another example, a usage demand for a particular cell tower in a wireless network may be predicted using past time series data. Similarly, the level of energy utility consumption with respect to a cell tower may be predicted via time series forecasting. In different use cases, resources predicted via time series forecasting may be allocated prior to the actual demand arrives to avoid potential problems.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts a scheme for a chronologically aware (CA) time series forecaster, in accordance with an embodiment of the present teaching;

FIG. 1B illustrates exemplary types of chronologically aware sequences (CASs) calibrated against some example occasions, in accordance with an embodiment of the present teaching;

FIG. 1C depicts an exemplary architecture of an application of enhanced time series forecasting via adaptive CAS calibration, in accordance with an embodiment of the present teaching;

FIG. 1D illustrates exemplary types of network service management tasks that can improve their performance based on enhanced CA time series forecasts, according to an embodiment of the present teaching;

FIG. 2A depicts an exemplary high level system diagram of a CA time series forecaster, in accordance with an embodiment of the present teaching;

FIG. 2B illustrates visually the concept of CA time series forecasting, in accordance with an embodiment of the present teaching;

FIG. 3A depicts an exemplary high-level system diagram of an enhanced time series forecaster, in accordance with an embodiment of the present teaching;

FIG. 3B is a flowchart of an exemplary process for obtaining CA TS forecast models, in accordance with an embodiment of the present teaching;

FIG. 3C is a flowchart of an exemplary process for predicting CA forecasts based on trained CA TS prediction models, in accordance with an embodiment of the present teaching;

FIG. 4A depicts an exemplary high level system diagram of a CAS forecaster, in accordance with an embodiment of the present teaching;

FIG. 4B is a flowchart of an exemplary process for obtaining CAS forecast models, in accordance with an embodiment of the present teaching;

FIG. 4C is a flowchart of an exemplary process for predicting CA forecasts based on trained CAS forecast models, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

Users may access various services via a network, through different network radio networks (RANs). It is important to accurately forecast the resource needs at these different RANs so that RANs run effectively and efficiently. The forecasted resources may be preemptively allocated to individual RANs to ensure smooth operation. However, forecasting the resource needs based on time series data collected from network operation poses challenges. For example, existing approaches often struggle to account for the nuanced data streams that are also affected by external factors such as network interruptions, use equipment movement patterns, holidays or special events. These irregularities are difficult to predict without specifically modeling each and lead to inaccuracies in predictions, resulting in either significant over estimation or under estimations. That is, traditional approaches are typically ill-equipped to deal with unexpected or unusual data points. As such, they are incapable of capturing complex yet repeatedly occurring patterns, especially with unfixed seasonality, and struggle to provide acceptable predictions.

To address these issues, an enhanced solution for network forecasting considers temporal patterns associated with both standard/regular data patterns (e.g., on weekdays) and non-standard events/occasions (e.g., weekend days, holidays, special event days) to adjust for the impact from such non-standard prediction points in combination with the regular data patterns. Integrating such different patterns and modeling thereof can improve accuracy of a time series model for prediction across different time scales (e.g., weekends, yearly holidays) to generate more accurate predictions of network forecasts. This ensures adaptability to diverse datasets and flexibility in forecasting specific days, weeks, or periods, while taking into account both historical and external factors.

The present teaching discloses an improved framework for network forecasting incorporating both traditional time series data and adaptive chronological aware sequences capturing patterns of specific non-standard events/occasions (weekends, holidays, events, etc.). Using the enhanced forecasting, exemplary embodiments allow for adjusting the temporal patterns to generate data that offers a more flexible and granular solution to overcome the limitations associated with the traditional approaches. The network forecast scheme of the present teaching is a chronologically aware (CA) time series forecaster that incorporates chronologically aware sequences (CASs), each of which captures the pattern of a corresponding specific non-standard event/occasion, to predict a time series forecast by incorporating both standard and non-standard data patterns to improve the prediction accuracy.

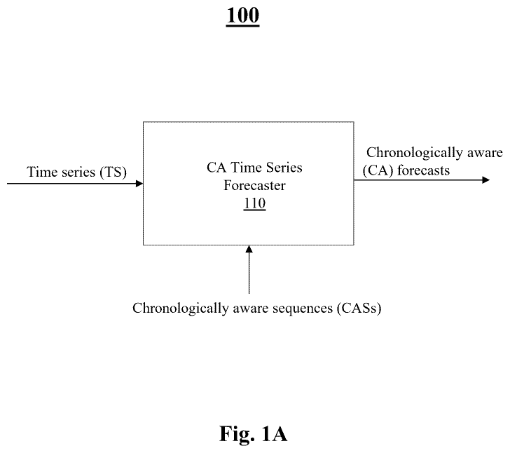

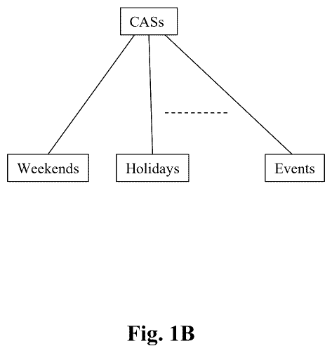

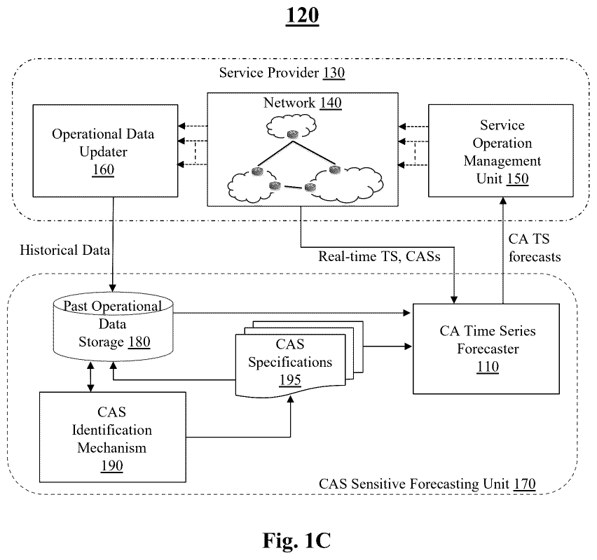

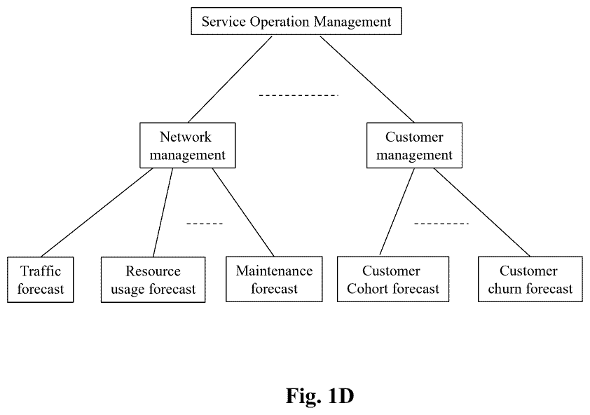

According to the present teaching, with respect to each of different defined CASs, prediction models may be developed based on past CAS data stream and used to predict a CAS forecast based on actual CAS collection during an operation of an application environment. Both the actual CAS data as well as the predicted CAS forecast are used, in combination with the real-time time series (TS), to predict an CA TS forecast. FIG. 1A depicts a scheme 100 for a chronologically aware (CA) time series forecaster 110, in accordance with an embodiment of the present teaching. In this exemplary depiction, the CA time series forecaster 110 takes both the standard TS as well as CASs as input and outputs a chronologically aware (CA) forecast. The illustrated scheme is distinct from the traditional approaches, which takes only TS and outputs a forecast based on the TS input. Different types of non-standard or special events/occasions may be relevant to a specific application and each of such non-standard or special events/occasions, each of which may be separately modeled to capture the pattern associated therewith. Such individually captured models may then be used in the CA forecasting scheme according to the present teaching to enhance the accuracy of the time series prediction. FIG. 1B illustrates exemplary types of CASs calibrated against some example occasions, in accordance with an embodiment of the present teaching. As discussed herein, some CASs may be associated with weekends (e.g., Saturday and Sunday), holidays (e.g., New Year, Christmas, Mother's Day, etc.), . . . , different special events/occasions (e.g., Superbowl day, annual jazz festival in the locale, scheduled sports events, etc.).

FIG. 1C depicts an exemplary application environment 120 for network operation management that deploys the CA TS forecasting framework, in accordance with an embodiment of the present teaching. In this illustration, the application environment 120 includes a service provider 130 and a CAS sensitive forecasting unit 170. In some embodiments, the service provider 130 may correspond to a wireless communication service provider which may include a network 140, through which wireless services are delivered to customers, a service operation management unit 150 for managing different aspects of the network to ensure service performance, and an operational data updater 160 for collecting dynamic historical data embedded with CASs.

The continually collected historical data from the service operation via the network 140 is provided to the CAS sensitive forecasting unit 170, which is to forecast various measures or target metrics defined according to the needs of the service provider 130. For example, the service operation management unit 150 may operate to manage different network components to ensure the performance of the network with respect to some specified targets, e.g., predicted needs for bandwidth, memory, or other resources for each cell tower, etc. to appropriately manage the network in a way to ensure quality service. Based on the specified targets, the trending needs with respect to each of the targets may be forecasted by the CAS sensitive forecasting unit 170 based on time series collected in real time in accordance with forecasting models obtained via machine learning based on the historical data. As seen in this application environment 120, the historical data is received from the operational data updater 160 and archived in a past operational data storage 180. A CAS identification mechanism 190 may be provided to create CAS specifications 195, which is used by the CA time series forecaster 110 to identify, from the historical data in a past operational data storage 180, data associated with each of the CASs as well as the historical time series. For example, the CAS identification mechanism 190 may facilitate interactions with a human operator to define different CASs corresponding to different events/occasions, which are considered impact the time series forecasts. Such defined CASs may be specified with associated parameters to allow identification of each CAS from time series data. The historical data (TS and CASs) is used by the enhanced time series forecaster 110 to obtain relevant forecasting models, which are then used in real time to predict, based on time series (with TS and CASs) collected in real time from the operation of the service provider 130, the CA TS forecasts. The predicted CA TS forecasts are then provided to the service operation management unit 150, which manages the network 140 according to the received forecasts.

FIG. 1D illustrates exemplary types of network service management tasks that can improve their performance based on enhanced CA time series forecasts, according to an embodiment of the present teaching. For example, the service provider 130 may desire to manage the service according to both the aspect related to network performance and the aspect of customer satisfaction. With respect to management of the network performance, the targets may be directed to traffic forecast, resource allocation, predictive maintenance associated with, e.g., each of the towers in each service regions, and the like. With respect to effort directed to customer satisfaction, the targeted aspects to be managed may include custom cohorts (e.g., for detecting preferences with respect to different user cohorts) and custom churn predictions so that preemptive measures may be adopted to prevent churns.

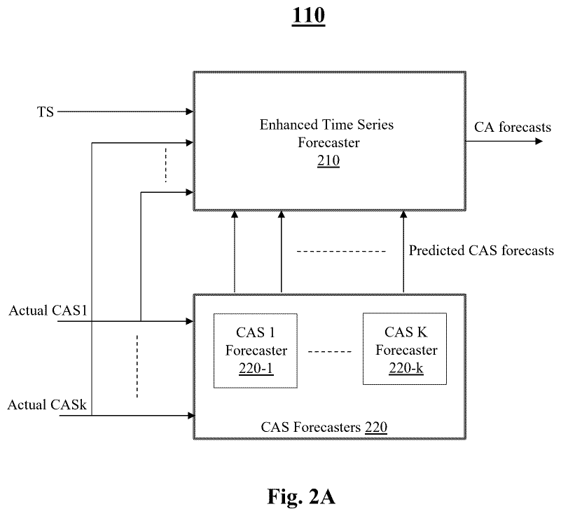

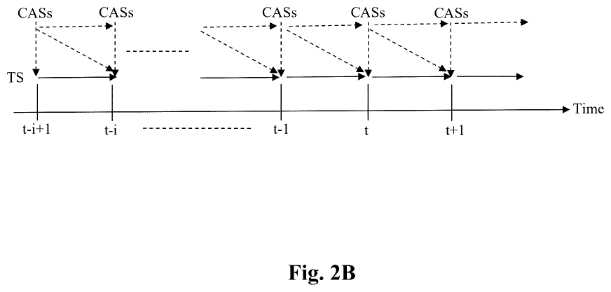

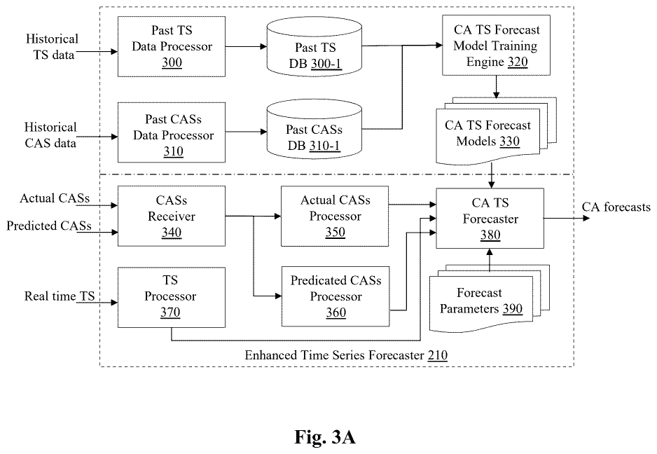

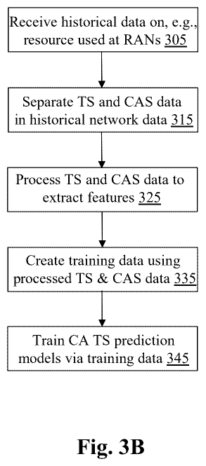

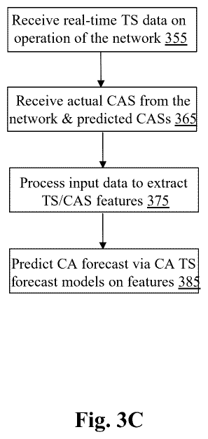

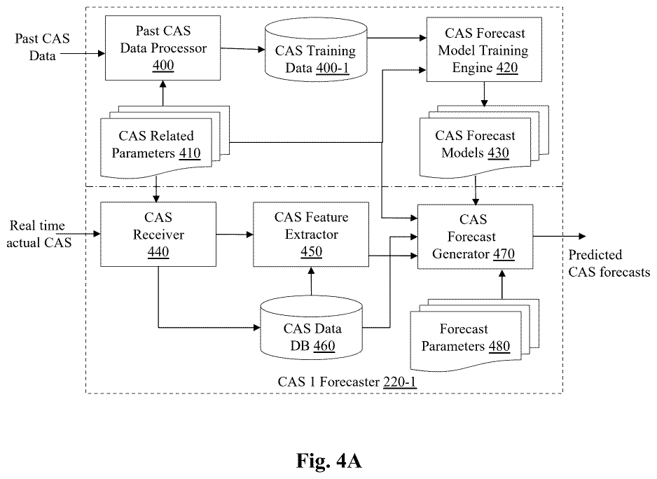

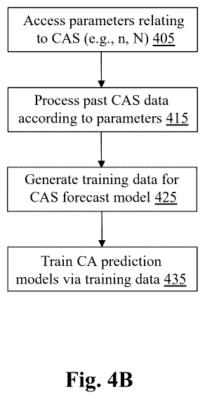

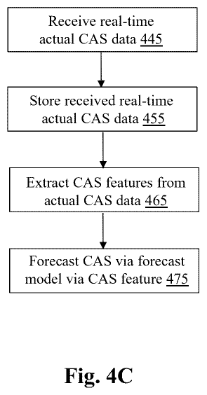

FIG. 2A depicts an exemplary high level system diagram of the CA time series forecaster 110, in accordance with an embodiment of the present teaching. In this illustrated embodiment, the CA time series forecaster 110 comprises an enhanced time series forecaster 210 and a collection of K CAS forecasters 220, i.e., CAS 1 forecaster 220-1-CAS k forecaster 220-k. Each of the CAS forecasters 220 is provided to take corresponding actual CAS data collected from network 140 and generate a predicted CAS forecast according to CAS forecasting models trained for the specific CAS. Such predicted CAS forecasts from 220 are provided to the enhanced time series forecaster 210, in combination with the real-time TS and different actual CAS data streams, so that it generates improved CA forecasts, as shown in FIG. 2A. Details about the enhanced time series forecaster 210 are provided with reference to FIG. 3A-3C. Details about a CAS forecaster are provided with reference to FIG. 4A-4C.

FIG. 2B illustrates visually the concept of CA time series forecasting, in accordance with an embodiment of the present teaching. Along an axis on time, there are points of forecasting at t−i+1, t−i, . . . t, t+1. There are two parallel prediction tracks, one for enhanced TS prediction and the other for each of the CAS predictions. At each forecasting point, e.g., at time instant t, an enhanced TS forecast is made based on a TS input (solid line), actual CASs (vertical dotted line), as well as the predicted CAS forecasts (slanted dotted line) from the previous point at t−1, consistent with what is depicted in FIG. 2A.

As discussed herein, each CAS is associated with a specific day/period/event/occasion such as each Saturday, Memorial Day, Christmas, New Year, the black Friday weekend, an annual Jazz Festival, or a local sports game, etc. As such, each CAS may be associated with some parameters, including the timeframe in a year for the CS, the length of the occasion, etc. Such associated parameters may be relied on in processing data, e.g., extracting CAS data from raw TS data based on the timeframe parameter, calibrating each CAS, and forecasting. For example, assume that a CAS is defined to be the first Sunday in the first week of April each year. In this example, the CAS is denoted by t and the first week of April is denoted by p. The values associated with each day of the first week of April are obtained from the time series data and the values corresponding to days other than Sunday (i.e., Monday, Tuesday, Wednesday, Thursday, Friday, Saturday) may be used to determine an average, denoted as Avg(p−t). To determine the CAS of a specific timeframe, the value associated with Sunday in the same period, denoted as V (t, p), may be determined by dividing this value by the averaged value of the remaining values of other days in the same period. Generally,

CAS(t,p)=V(t,p)/Avg(p−t)

The example CAS (Sunday for the first week of April) may be determined from the time series data by calculating all combinations of t, p present in the data. That is, CAS (t, p) represents a calibrated chronologically aware sequence of the specific timeframe “t” (Sunday) and period “p” (first week of April). In this way, for each CAS defined with respect to a specific t and p, the CAS may be determined based on the received time series data.

As disclosed herein, the CASs are incorporated into the CA time series forecast operation. For example, if the time series forecast is predicted on a daily basis and if the day to be predicted fall on a special day such as a weekend day, a holiday, a special event day, then the calibrated CAS value will be used for the prediction, either in place of other values or in combination with the other values considered. In some embodiments, the value of the calibrated CAS used in the forecasting may be obtained from multiple previous “n” periods, where n is a specified operational parameter, either predetermined by, e.g., the service provider 130 or the service operation management 150 to ensure the quality of the enhanced forecasting. In some embodiments, the operational parameter n may also be dynamically determined by the CA time series forecaster 110 based on, e.g., past performance metrics. For example, to determine the CAS for Sunday of the first week of March, instead of using data from the other weekdays of that week, the calibrated value of the CAS for Sunday may be obtained based on CAS values associated with past “n” Sundays, each of which would have been calculated using the steps as discussed herein (i.e., dividing the value for Sunday by values of other weekdays of the same week). That is,

CAS(t,p)=[CAS(t,p−1)+CAS(t, p−2)+ . . . +CAS(t,p−n)]/n

Each CAS may be calibrated separately according to the nature of the defined CAS. For instance, the CAS for Sunday may be calibrated differently from that for CAS defined for an annual festival. Each CAS may be calibrated based on all available timeframes provided in the data.

FIG. 3A depicts an exemplary high-level system diagram of the enhanced time series forecaster 210, in accordance with an embodiment of the present teaching. In this illustrated embodiment, the enhanced time series forecaster 210 comprises two portions. The first portion is provided for obtaining CA TS forecast models 330, via a CA TS forecast model training engine 320 based on training data associated with both historical TS data 300-1 (generated by a past TS data processor 300 based on historical TS data) and historical CASs data 310-1 (generated by a past CAS data processor 310 based on historical CAS data). As such obtained CA TS forecast models 330 are machine learned based on both TS and CAS data, they learn how to generate a forecast based on the dynamics of both TS and CASs, which represents an enhancement when compared with a traditional TS forecast. The CA TS forecast models 330 may be continually updated based on the dynamics represented by the continuously collected historical data so that the models are adaptive.

The second portion of the enhanced time series forecaster 210 may be provided for predicting CA forecasts, using the CA TS forecast models 330, in accordance with the input including real time TS data, actual collected CASs, as well as predicted future CASs produced respectively by the CAS forecasters 220. This portion comprises a CASs receiver for receiving CAS related input (including both actual and predicted CASs), a TS processor for receiving real time TS data and carrying out the processing (e.g., extract features from the TS), an actual CASs processor for processing (e.g., extracting features) the actual CAS data collected from the service operation, a predicted CASs processor 360 for processing the predicted CASs output from different CAS forecasters 220, and CA TS forecaster 380 for forecasting, based on features extracted from input (TS, actual and predicted CASs) using the CA TS forecast models 330 to generate the CA forecast.

FIG. 3B is a flowchart of an exemplary process for obtaining CA TS forecast models, in accordance with an embodiment of the present teaching. As discussed herein, historical data from past operation of the network 140 may be used to obtain the CA TS prediction models 330. For example, to forecast the resource needs of various RANs in network 140, the historical data may include information on past consumption of resources at respective RANs. When such historical data (representative of the resource usage of different RANs in the network operation) is received at 305, TS and CAS data embedded in the historical data on, e.g., resource consumption at RANs on either standard or non-standard periods, are respectively recognized and separated at 315. The separate TS and CAS data are processed by the past TS data processor 300 and the past CASs data processor 310 at 325 to extract respective features, which are used to create, at 335, training data to be used for machine learning the CA TS forecast models 330. The CA TS forecast model training engine 320 is then invoked to train, at 345, the CA TS prediction models 330.

FIG. 3C is a flowchart of an exemplary process for predicting CA forecasts from real time input based on trained CA TS prediction models, in accordance with an embodiment of the present teaching. In the service operation as illustrated in FIG. 2A, the real time TS data, e.g., relating to the resource usage at various RANs in network 140, is received at 355, and the CAS data, including both the actual CAS from the network 140 and the predicted based on such actual CASs, is received at 365. Different processors (340, 350, and 370) process, at 375, the respective TS data, actual CAS data, and the predicted CAS data to extract relevant features therefrom. Based on such extracted features, the CA TS forecaster 380 predicts, at 385, the CA forecast in accordance with the trained CA IS forecast models 330.

As discussed herein, for each defined CAS, there is a CAS forecaster for estimating a predicted CAS forecast based on actual CAS received during the operation. The predicted CAS forecasts for different CASs may then be sent to the enhanced time series forecaster 210 for making an enhanced forecast based on overall consideration of both real time TS data, the actual CASs, as well as the predicted CAS forecasts. In some embodiments, each of the CAS forecasters may be constructed similarly to derive individually trained forecasting models specifically directed to the corresponding CAS. FIG. 4A depicts an exemplary high-level system diagram of a CAS forecaster (e.g., 220-1), in accordance with an embodiment of the present teaching. The input to the CAS forecaster 220-1 includes past CAS data and real time actual CASs. The CAS data, whether past or actual, is derived via calibration as discussed herein.

In this illustrated embodiment, the CAS forecaster 220-1 comprises two portions. The first portion is provided for obtaining, e.g., via machine learning, CAS forecast models 430, by a CAS forecast model training engine 420 based on CAS related training data stored in a storage 400-1. The CAS training data 400-1 may be generated by a past CAS data processor 400 based on input past CAS data and CAS related parameters specified in 410. In some embodiments, the CAS related parameters in 410 may include both parameters in generating robust training data (e.g., n used to generate more reliable calibrated CAS data) as well as parameters used in generating a predicted CAS forecast. The data to be used to create the training data in 400-1 is selected from the past CAS data with respect to a defined t (e.g., Saturday) and p (e.g., first week of April). With such training data, the CAS forecast model training engine 420 conducts machine learning to obtain the CAS forecast models 430.

In some embodiments, the input CAS data may be expanded based on parameters specified in 410. For example, a parameter may be directed to a prediction horizon, denoted by N, defining an additional period for forecast. As an example, the input CAS data may span from January 2024 to August 2024 and a forecast is needed for September to December 2024. The past CAS data processor 400 may use the input CAS data for January-August as exogenous variables to obtain a best fit time-series model for forecasting corresponding calibrated CAS for the September to December period. That is, the input calibrated CAS data may be used to derive additional CAS data. This model may also be optimized using cross-validation to find the best parameters and then used to calibrate the CAS for the extrapolated CAS data for the upcoming four months. Such expanded CAS data may be used as training data for the CAS forecast model training engine 420 to learn, e.g., via machine learning the CAS forecast models 430 for the associated non-standard event/occasion (e.g., Sunday). In some embodiments, the CAS forecast models 430 may be continually updated based on the dynamics represented by the continuously collected historical data so that the models are adaptive.

The second portion of the CAS 220-1 is for estimating a predicted CAS forecast based on input actual CAS in accordance with the CAS forecast models 430. This portion comprises a CAS receiver 440 for receiving an actual CAS input, a CAS feature extractor 450 for extracting features from the input actual CAS data and archiving in a CAS data database 460, and a CAS forecast generator 470 for estimating a predicted CAS forecast based on the input CAS data and extracted features thereof using the CAS forecast models 430 in accordance with forecast parameters 480 which may be specified to control the forecasting operation.

FIG. 4B is a flowchart of an exemplary process for obtaining CAS forecast models, in accordance with an embodiment of the present teaching. When the past CAS data (identified from the historical data) is received, the past CAS data processor 400 accesses, at 405, parameters stored in the CAS related parameters (such as n and N) and processes, at 415, the past CAS data accordingly based on the retrieved parameters and generates, at 425, the CAS training data in 400-1. Based on the CAS training data, the CAS forecast model training engine 420 carries out the training at 435 to derive the CAS forecast models 430.

FIG. 4C is a flowchart of an exemplary process for predicting predicted CAS forecast based on trained CAS forecast models 430, in accordance with an embodiment of the present teaching. In operation, when the CAS receiver 440 receives, at 445, the actual CAS data, it stores, at 455, the received raw CAS data in the CAS data database 460. Based on the archived actual CAS data, the CAS feature extractor 450 extracts, at 465, CAS features characterizing the actual CAS data. The CAS forecast generator 470 estimates, at 475, a predicted CAS forecast based on the actual CAS data and the CAS features in accordance with the CAS forecast models 430. Such generated predicted CAS forecast is provided, together with the corresponding actual CAS data, to the enhanced time series forecaster 210. All CAS forecasters 220 as shown in FIG. 2A generate their respective predicted CASs in this manner that are used by the enhanced time series forecaster 210 to forecast CA forecasts incorporating data patterns associated with both standard TS data as well as non-standard CASs to produce more accurate forecasts.

As discussed herein, the enhanced time series forecast approach according to the present teaching produces predictions using models trained by learning both the influence to forecasts from normal or standard time series patterns and the impact from data patterns associated with non-standard or occasionally occurring events. As discussed herein with the network management application on forecasting resource needs of various RANs, the enhanced forecasting modeling and predictions according to the present teaching yields more accurate forecasts. Embodiments of the current disclosure may be used to derive more accurate time series forecasts by integrated consideration of impact to a forecast from data streams that exhibit diverse patterns. For example, accurately forecasting time series data using the present teaching may also benefit use cases in various domains, including finance, retail, supply-chain, telecommunications, etc.

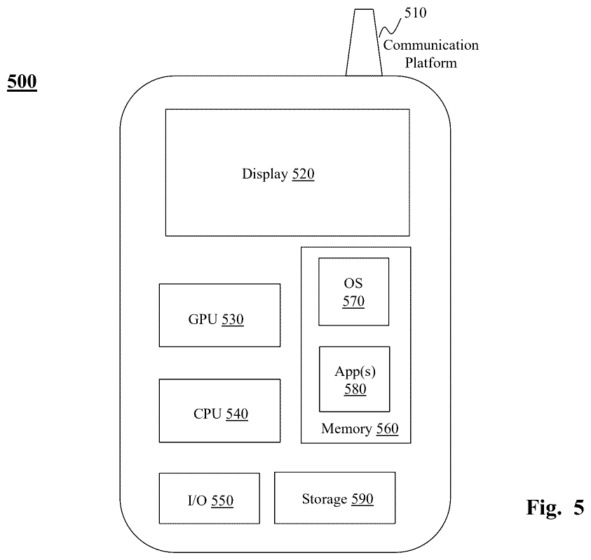

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or a mobile computational unit in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.) and one or more applications 580 may be loaded into memory 560 from storage 590 to be executed by the CPU 540. The applications 580 may include a user interface or any other suitable mobile apps for information exchange, analytics, and management according to the present teaching on, at least partially, the mobile device 500. User interactions, if any, may be achieved via the I/O devices 550 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

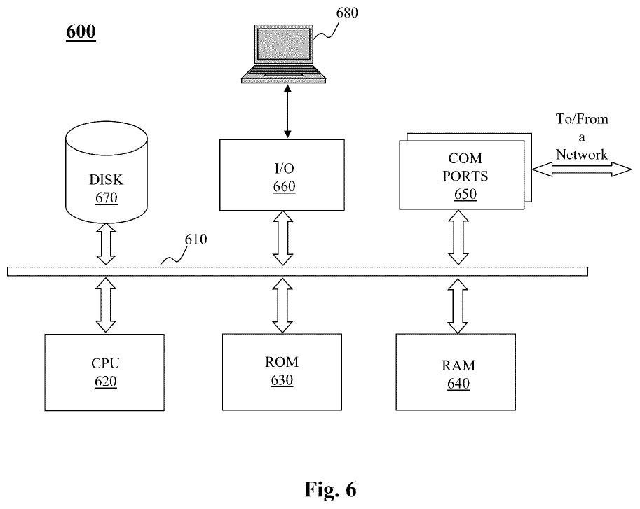

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 600 may be used to implement any component or aspect of the framework as disclosed herein. For example, the information processing and analytical method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method for forecasting resource need associated with a network, comprising:
receiving historical data representing time series (TS) data characterizing previous resource consumption of the network;
generating CAS specifications about one or more chronologically aware sequences (CASs) corresponding to respective events that impact the resource consumption of the network, wherein the CASs are embedded in the historical data;
creating, from the historical data, past TS data and past CAS data, wherein the past CAS data includes one or more past CAS data sets corresponding to the CASs created based on the CAS specifications;
obtaining a chronologically aware (CA) TS forecast model based on the past TS data and the past CAS data for estimating an enhanced time series forecast based on real time TS data collected from the network;
for each of the CASs, obtaining a CAS forecast model based on a corresponding past CAS data set for estimating a predicted CAS forecast based on actual CAS data identified from the real time TS data;
receiving the real time TS data collected during operation of the network representing a current operational state of the network, wherein the real time TS data embeds one or more actual CASs associated with the events;
based on each of the one or more actual CASs, estimating a predicted CAS forecast using a corresponding CAS forecast model to generate one or more predicted CAS forecasts;
estimating, using the CA TS forecast model, an enhanced time series forecast based on the real time TS, the one or more actual CASs, and the one or more predicted CAS forecasts.

2. The method of claim 1, wherein the CAS specifications define each of the CASs in connection with a respective one of the events with calibration parameters to be used to calibrate the CAS.

3. The method of claim 2, wherein the calibration parameters associated with each of the CASs include at least one of:
a first parameter t representing a timeframe of one of the events in connection with the CAS; and
a second parameter p representing a period of the event in connection with the CAS.

4. The method of claim 3, further comprising at least one of:
a third parameter n representing a number of previous periods of the CAS included in the historical data; and
a fourth parameter N representing a prediction horizon.

5. The method of claim 2, wherein the step of obtaining a CAS forecast model for a respective CAS comprises:
accessing calibration parameters relating to the respective CAS;
processing the past CAS data set for the respective CAS based on the calibration parameters to generate training data; and
training, based on the training data, the CAS forecast model.

6. The method of claim 1, wherein the step of obtaining the CA TS forecast model comprises:
processing the past TS data and the past CAS data;
creating combined training data based on the processed past TS data and the processed past CAS data; and
training, based on the combined training data, the CA TS forecast model.

7. The method of claim 1, further comprising:
providing the enhanced time series forecast to a network management mechanism that operates to manage the operation of the network accordingly based on the enhanced time series forecast.

8. A machine-readable and non-transitory medium having information recorded thereon for forecasting resource need associated with a network, wherein the information, when read by the machine, causes the machine to perform the following steps:
receiving historical data representing time series (TS) data characterizing previous resource consumption of the network;
generating CAS specifications about one or more chronologically aware sequences (CASs) corresponding to respective events that impact the resource consumption of the network, wherein the CASs are embedded in the historical data;
creating, from the historical data, past TS data and past CAS data, wherein the past CAS data includes one or more past CAS data sets corresponding to the CASs created based on the CAS specifications;
obtaining a chronologically aware (CA) TS forecast model based on the past TS data and the past CAS data for estimating an enhanced time series forecast based on real time TS data collected from the network;
for each of the CASs, obtaining a CAS forecast model based on a corresponding past CAS data set for estimating a predicted CAS forecast based on actual CAS data identified from the real time TS data;
receiving the real time TS data collected during operation of the network representing a current operational state of the network, wherein the real time TS data embeds one or more actual CASs associated with the events;
based on each of the one or more actual CASs, estimating a predicted CAS forecast using a corresponding CAS forecast model to generate one or more predicted CAS forecasts;
estimating, using the CA TS forecast model, an enhanced time series forecast based on the real time TS, the one or more actual CASs, and the one or more predicted CAS forecasts.

9. The medium of claim 8, wherein the CAS specifications define each of the CASs in connection with a respective one of the events with calibration parameters to be used to calibrate the CAS.

10. The medium of claim 9, wherein the calibration parameters associated with each of the CASs include at least one of:
a first parameter t representing a timeframe of one of the events in connection with the CAS; and
a second parameter p representing a period of the event in connection with the CAS.

11. The medium of claim 10, wherein the information, when read by the machine, further causes the machine to perform at least one of the following steps:
a third parameter n representing a number of previous periods of the CAS included in the historical data; and
a fourth parameter N representing a prediction horizon.

12. The medium of claim 9, wherein the step of obtaining a CAS forecast model for a respective CAS comprises:
accessing calibration parameters relating to the respective CAS;
processing the past CAS data set for the respective CAS based on the calibration parameters to generate training data; and
training, based on the training data, the CAS forecast model.

13. The medium of claim 8, wherein the step of obtaining the CA TS forecast model comprises:
processing the past TS data and the past CAS data;
creating combined training data based on the processed past TS data and the processed past CAS data; and
training, based on the combined training data, the CA TS forecast model.

14. The medium of claim 8, wherein the information, when read by the machine, further causes the machine to perform the following steps:
providing the enhanced time series forecast to a network management mechanism that operates to manage the operation of the network accordingly based on the enhanced time series forecast.

15. A system for forecasting resource need associated with a network, comprising:
an enhanced time series forecaster implemented by a processor and configured for:
receiving historical data representing time series (TS) data characterizing previous resource consumption of the network,
generating CAS specifications about one or more chronologically aware sequences (CASs) corresponding to respective events that impact the resource consumption of the network, wherein the CASs are embedded in the historical data,
creating, from the historical data, past TS data and past CAS data, wherein the past CAS data includes one or more past CAS data sets corresponding to the CASs created based on the CAS specifications, and
obtaining a chronologically aware (CA) TS forecast model based on the past TS data and the past CAS data for estimating an enhanced time series forecast based on real time TS data collected from the network;
for each of the CASs, a CAS forecaster implemented by a processor and configured for obtaining a CAS forecast model based on a corresponding past CAS data set for estimating a predicted CAS forecast based on actual CAS data identified from the real time TS data; and
a CA time series forecaster implemented by a processor and configured for:
receiving the real time TS data collected during operation of the network representing a current operational state of the network, wherein the real time TS data embeds one or more actual CASs associated with the events,
based on each of the one or more actual CASs, estimating a predicted CAS forecast using a corresponding CAS forecast model to generate one or more predicted CAS forecasts, and
estimating, using the CA TS forecast model, an enhanced time series forecast based on the real time TS, the one or more actual CASs, and the one or more predicted CAS forecasts.

16. The system of claim 16, wherein
the CAS specifications define each of the CASs in connection with a respective one of the events with calibration parameters to be used to calibrate the CAS; and
the calibration parameters associated with each of the CASs include at least one of:
a first parameter t representing a timeframe of one of the events in connection with the CAS, and
a second parameter p representing a period of the event in connection with the CAS.

17. The system of claim 16, wherein the calibration parameters further include at least one of:
a third parameter n representing a number of previous periods of the CAS included in the historical data; and
a fourth parameter N representing a prediction horizon.

18. The system of claim 16, wherein the step of obtaining a CAS forecast model for a respective CAS comprises:
accessing calibration parameters relating to the respective CAS;
processing the past CAS data set for the respective CAS based on the calibration parameters to generate training data; and
training, based on the training data, the CAS forecast model.

19. The system of claim 15, wherein the step of obtaining the CA TS forecast model comprises:
processing the past TS data and the past CAS data;
creating combined training data based on the processed past TS data and the processed past CAS data; and
training, based on the combined training data, the CA TS forecast model.

20. The system of claim 15, further comprising:
providing the enhanced time series forecast to a network management mechanism that operates to manage the operation of the network accordingly based on the enhanced time series forecast.
